(19) United States
(12) Patent Application Publication
(10) Pub. No.: US 2009/0144230 A1
(43) Pub. Date: Jun. 4, 2009

(54) ADDRESS LIST GENERATION SYSTEM AND METHOD EMPLOYING A GEOGRAPHICAL BUFFER ZONE

(76) Inventor: David Fant, Grand Rapids, MI (US)

Correspondence Address: MCGARRY BAIR PC, 32 Market Ave. SW, SUITE 500, GRAND RAPIDS, MI, 49503, US

(21) Appl. No.: 12/015,820

(22) Filed: Jan. 17, 2008

Related U.S. Application Data
(60) Provisional application No. 60/886,816, filed on Jan. 26, 2007.

(51) Int. Cl. G06F 7/06; G06F 17/30

(52) U.S. Cl. 707/2; 707/E17.017

(57) ABSTRACT

A method for generating an address list from a database of addresses comprises the steps of receiving at least one geographical criterion from a user, identifying a first geographical region from a user, forming a second geographical region by modifying the first geographical region pursuant to the at least one geographical criterion, wherein the second geographical region is not of the same geographical size as the first geographical region, and generating a list of addresses from the database of addresses which fall within the second geographical region.

### CROSS-REFERENCE TO RELATED APPLICATION

This application claims the benefit of U.S. Provisional Application Ser. No. 60/886,816, filed Jan. 26, 2007, which is incorporated herein by reference in its entirety.

### BACKGROUND OF THE INVENTION

1. Field of the Invention

The invention relates to a system and method for address list generation employing a geographical buffer zone. Specifically, this invention relates to the direct mail industry, an industry that is used extensively to generate mailing lists that are used for advertising and customer promotion/prospecting. This application references the need to better target specific types of households through demographic/geographic techniques.

2. Description of the Related Art

It has long been a goal of the direct mail industry to target specific types of households. A sub-industry has developed in the generation of address lists for sale to particular demographic segments within a targeted population of a direct mailer. Through magazine subscription lists, membership rosters for clubs/professional organizations, donor lists for non-profit organizations, or basic household demographics (e.g., age, income, dwelling type, length of home occupation), direct marketers can better focus their mailings and become more effective in their use of their marketing dollars. This use of different highly targeted selection techniques is referred to as “target marketing,” or targeting the most responsive and interested prospects.

One difficulty experienced by direct mailers is an unacceptably low response rate to mailings. For example, it is often considered “acceptable” if less than one percent of a selected population receiving a mailing responds in some fashion. For example, if 5,000 mailings were sent out advertising a particular offer, and 50 people responded, the response would be considered acceptable. However, this would also mean that the vast majority of prospects receiving the mailing presumably ignored or discarded the mailing. The end result would be, and often is, an inefficient utilization of time, resources, and money. Thus, in theory, if the mailing were intelligently focused on prospects more likely to respond to the mailing, fewer mailings could be sent while more prospects would respond. In the example given above, if a focused mailing of 1,000 mailings were sent out and the same 50 prospects responded, the marketer would have saved the cost of 4,000 mailings to generate the same response.

One manner in which to focus mailings is to target a particular geographical region in which a target audience is expected to reside. This is typically done by sending mailings to a selected subset of a population. The subset to which a targeted mailing is directed can be based on ZIP codes, postal routes, telephone exchanges, or other geographical criteria.

By way of example, people who live directly on, or very near, water are prime candidates for targeting. There is a wide range of potential users for this type of market segment yet the ability to effectively target homes that are on the water is extremely difficult. In the past, a direct marketer had to evaluate what lake or water they wanted to mail to—then identify the ZIP code that the homes were in, and determine within each ZIP code which postal carrier/rural route actually touched the water. This process could take a ZIP code household population (typically around 8,000 to 15,000 households) and reduce it to 2-400 households. Yet, experience has demonstrated that, even using this “brute force” manual method, only a small percentage of homes actually were on or very near the water.

It is estimated that 80% of the homes in any one postal carrier route associated with water are not on or near the water. Thus, mailings can include far too many non-targeted consumers. The only way presently to know for certain which prospects are within a predefined relationship (e.g. distance) to the water is to visit each city, county, or township, and manually cull out those addresses that are within the predefined relationship to the water. If the target market area is large, such as nationwide, statewide, or regional, the task can be overwhelming.

As originally structured, the first three digits of the ZIP code identified a geographical region of the country, and the final two digits of the ZIP code coincided with a previously-used postal zone number. Currently, the U.S. Postal Service uses an expanded ZIP code system called “ZIP+4.” A ZIP+4 code uses the five-digit basic ZIP code plus an additional four digits to identify a geographic sub-area within the five-digit delivery area identified by the basic ZIP code. The sub-area can be a city block, a group of apartments, a building, an individual floor of a building, an area defined by its association with a high-volume receiver of mail, or any other sub-area for which efficient mail sorting and delivery can be aided by the use of an extra four digit identifier.

There are three levels of geography addressed in this application. A ZIP code typically identifies a very large geographic area of between 3,000 and 25,000 households. Each ZIP code is broken down into postal carrier or rural routes, each composed of homes that can be delivered to in one day by a single postal carrier. Typically a carrier/rural route comprises in the range of 150-300 households. Postal geography can also be further subdivided according to the ZIP+4 level or the USPS 9 digit ZIP code, which is the smallest geographical unit in use by the direct marketing industry for targeting prospective customers.

The advent of mapping software has facilitated the task of generating targeted address lists. By using software that shows each body of water and the streets surrounding the body of water, a direct marketer can readily compile a list of each street to “grab” each ZIP+4 code surrounding the body of water. This is a manual process using a computer, and requires “geo-coding,” or creating a custom polygon using a mouse and software to encircle or follow the body of water boundaries, “capturing” the ZIP+4 centroid in the process for homes that are on or very near a body of water. Although more effective than using an entire carrier route, the time required to code one county in any given state is typically an hour to an hour and a half. As an example, Michigan, with 83 counties, would require 103.75 man-hours to build the polygons needed to extract the ZIP+4 codes from a master database. For the entire United States, this translates to over 5,187 man-hours in encoding.

FIG. 1 is an illustration of a prior art system and method of using ZIP codes and postal routes as criteria against a location information database and applying a subset of records, such as the codes or postal routes, against a database of population information to generate an address list. In order to readily target lakefront homeowners, it would be advantageous to utilize a method that quickly and easily identifies each ZIP+4 code that falls within a selected radius of a selected geographical feature, such as a lake or water boundary.

### SUMMARY OF THE INVENTION

A method for generating an address list from a database of addresses comprises the steps of receiving at least one geographical criterion from a user, identifying a first geographical region from a user, forming a second geographical region by modifying the first geographical region pursuant to the at least one geographical criterion, wherein the second geographical region is not of the same geographical size as the first geographical region, and generating a list of addresses from the database of addresses which fall within the second geographical region.

### BRIEF DESCRIPTION OF THE DRAWINGS

In the drawings:

FIG. 1 is an illustration of a prior art system and method of using ZIP codes and postal routes as criteria against a location information database and applying a subset of records, such as the codes or postal routes, against a database of population information to generate an address list.

FIG. 2 is an illustration of a system and method according to the invention in which available ZIP code and postal route information in a location information database is filtered in an inventive method and system according to the invention to identify a targeted subset of records, and those subset of records are applied against a population information database to generate a specifically-targeted address list according to the invention.

FIG. 3 illustrates the invention described and shown with respect to FIG. 2 in greater detail in which geographical boundary data with an optional buffer zone is overlaid against a ZIP+4 database to identify an overlapping specifically targeted geographical region from which a generated list of ZIP+4 codes which lie within the boundary data is identified, applied against a population information database such as an address database to generate the specifically-targeted list of addresses described and shown in FIGS. 2-3.

FIG. 4 is an illustration, by example, of the State of New Jersey with all bodies of water shown thereon.

FIG. 5 is an illustration of the State of New Jersey illustrations shown in FIG. 4 with all ZIP+4 codes shown layered on the map of FIG. 4.

FIG. 6 is the map of FIG. 5 with an optional buffer zone applied to each water boundary shown in the maps of FIGS. 4-5.

FIG. 7 is an enlarged portion of the map shown in FIG. 4 with various water areas of the State of New Jersey shown in a dark color.

FIG. 8 is an enlarged portion of FIG. 5 of the same area shown in FIG. 7 showing various ZIP+4 regions laid onto the enlarged map of FIG. 7.

FIG. 9 is an enlarged portion of the map of FIG. 6 showing lines defining a buffer zone, shown by example in the drawings as a ⅛-mile inland circumference around each body of water shown on the maps of FIGS. 7-9, whereby ZIP+4 regions lying within the ordered buffer zones comprise the targeted consumers for generation of the address list via the method shown in FIGS. 2-3.

FIG. 10 shows an example table of ZIP+4 data contained in a typical mapping software package which data includes fields for ZIP code, ZIP+4 code, latitude, longitude, state, postal routes, and other geographical identifying data.

FIG. 11 shows a list of selected records identifying a body of water existing in the State of New Jersey issue in the maps of FIGS. 4-9 as well as a code identifying the particular body of water.

FIG. 12 shows an example query with the water boundary data having a buffer zone shown in FIG. 10 combined with the water boundary codes shown in FIG. 11 whereby the ZIP+4 codes listed in FIG. 12 are applied against a address list database to generate a targeted list of addresses comprising only those homes having a ZIP+4 code falling within the data shown in FIG. 12.

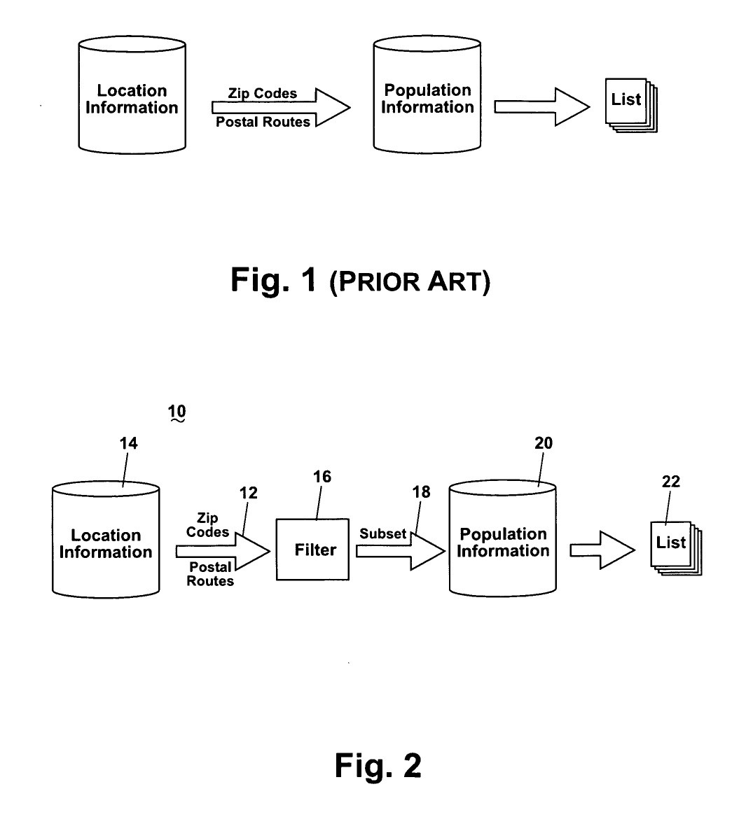

### DESCRIPTION OF AN EMBODIMENT OF THE INVENTION

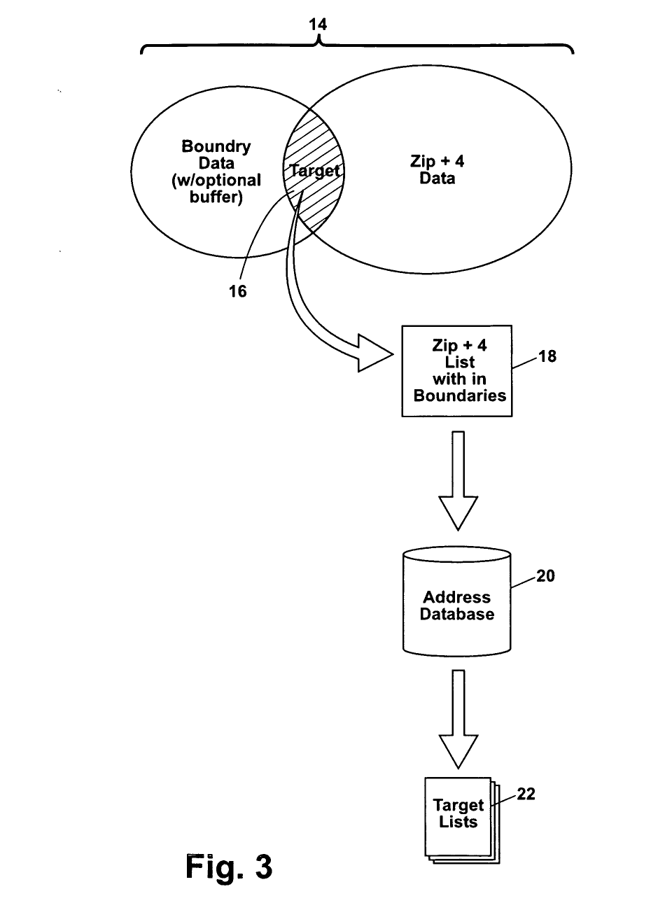

Referring now to the drawings, and to FIG. 2 in particular, an embodiment of the invention is illustrated comprising a system and method (identified generally by reference numeral 10) in which available ZIP code and postal route information 12 in a location information database 14 is passed through a filter 16 in the method and system 10 to identify a targeted subset of records 18, and those subset of records are applied against a population information database 20 to generate a specifically-targeted address list 22. FIG. 3 illustrates the method and system 10 described and shown with respect to FIG. 2 in greater detail. Geographical boundary data 14 with an optional buffer zone is overlaid against a ZIP+4 database (also part of the database 14) to identify an overlapping specifically targeted geographical region from which a generated list of ZIP+4 codes which lie within the boundary data is identified, applied against a population information database such as an address database to generate the specifically-targeted list of addresses described and shown in FIGS. 2-3.

The address list 22 can be generated according to any geographical location, range or plurality of geographical locations and/or selection of geographical regions according to the method and system 10. A buffer zone can be applied to the selected geographical region, such as a circumference around a geographical region of a particular distance. For example, the geographical region could be defined as a particular plat with a 1000-foot buffer zone around it to allow the method and system 10 to generate a list 22 of all addresses for people who live within 1000 feet of the particular plat. In addition, several geographical points can be selected, and a buffer zone of a common or different distance can be applied to each of the points for a list 22 to be developed for all people who live within any of the identified or selected buffer zones.

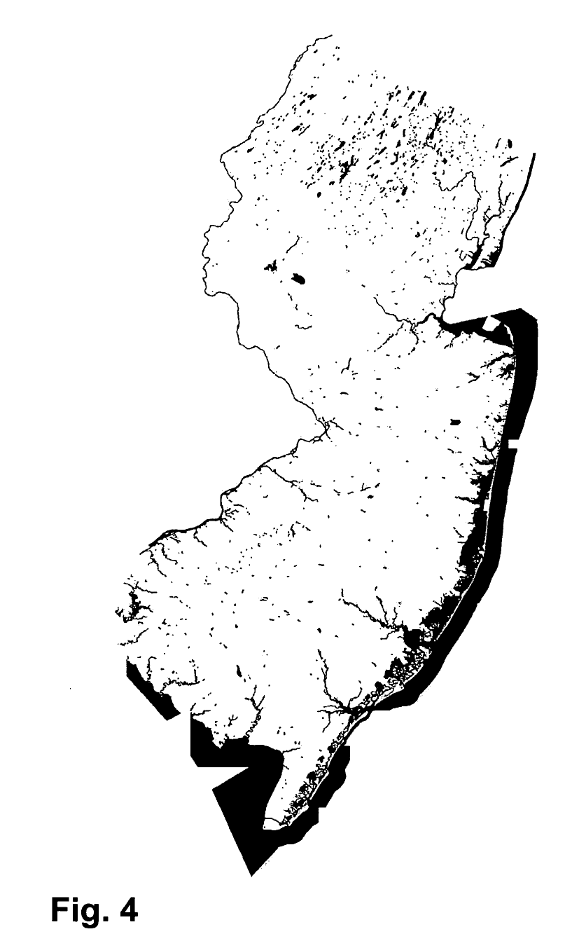

While examples of buffer zones and selected geographical regions are provided above, an example is provided in this application to show the ease by which the system and method 10 can be employed to determine all individuals who live within a certain distance from every body of water in a particular state, such as New Jersey in the example shown and described with respect to FIGS. 4-12.

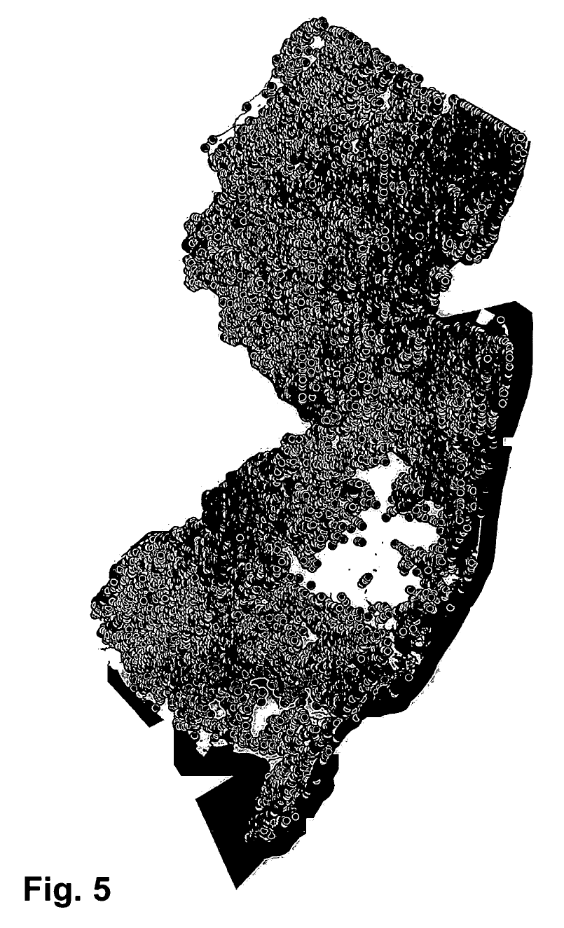

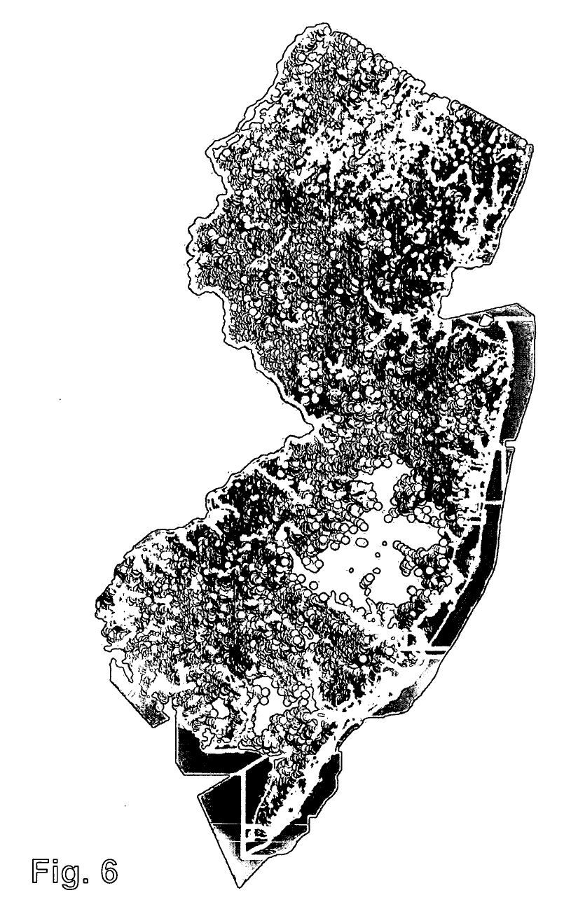

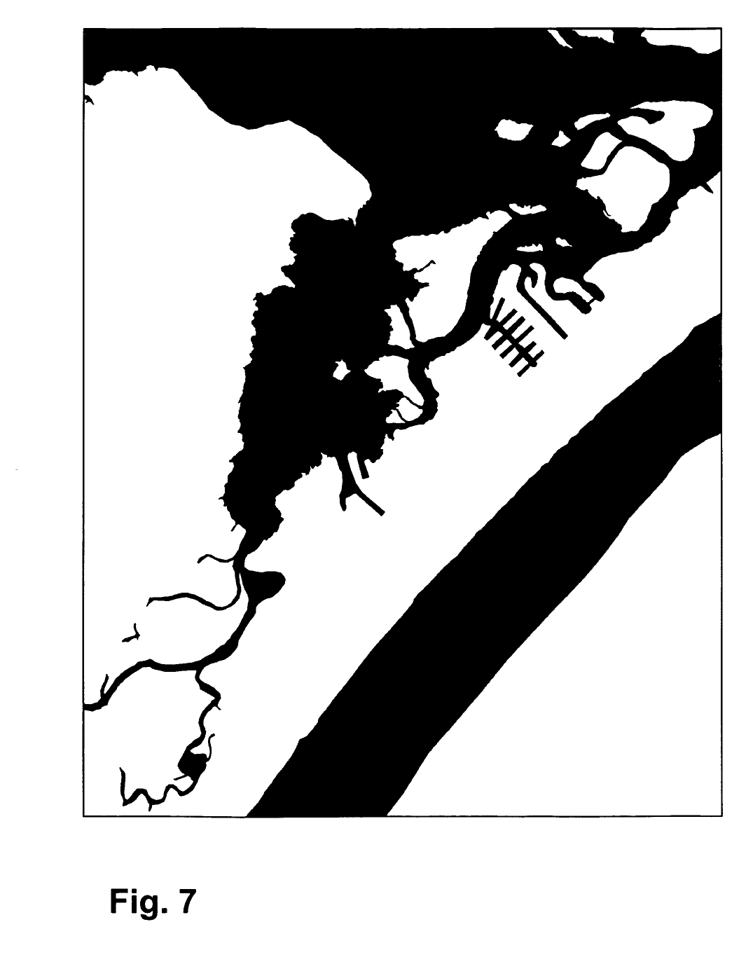

FIG. 4 is an illustration, by example, of the State of New Jersey with all bodies of water shown thereon. FIG. 5 is an illustration of the State of New Jersey illustrations shown in FIG. 4 with all ZIP+4 codes shown layered on the map of FIG. 4. FIG. 6 is the map of FIG. 5 with an optional buffer zone applied to each water boundary shown in the maps of FIGS. 4-5.

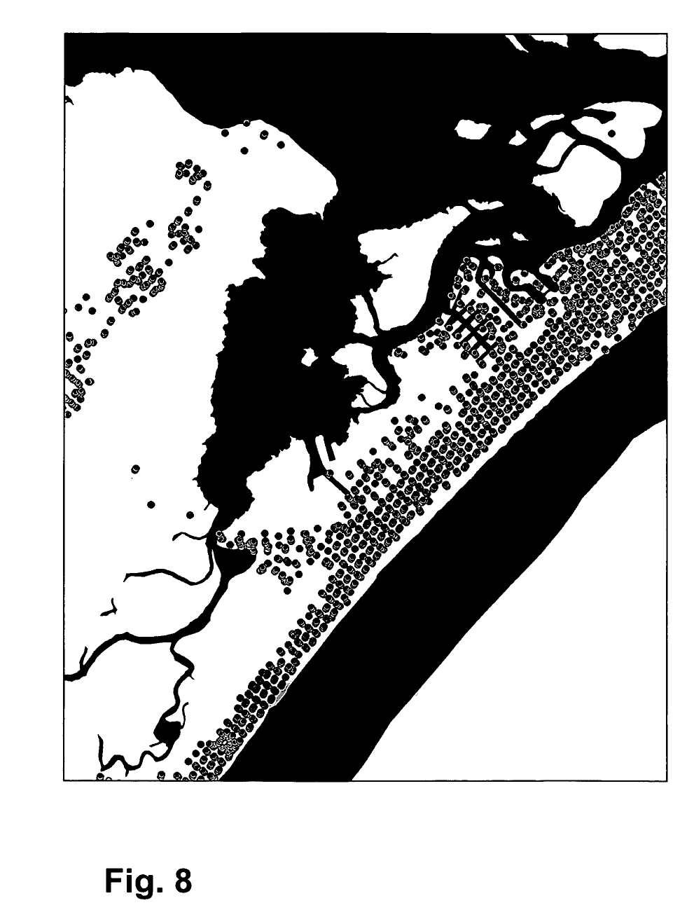

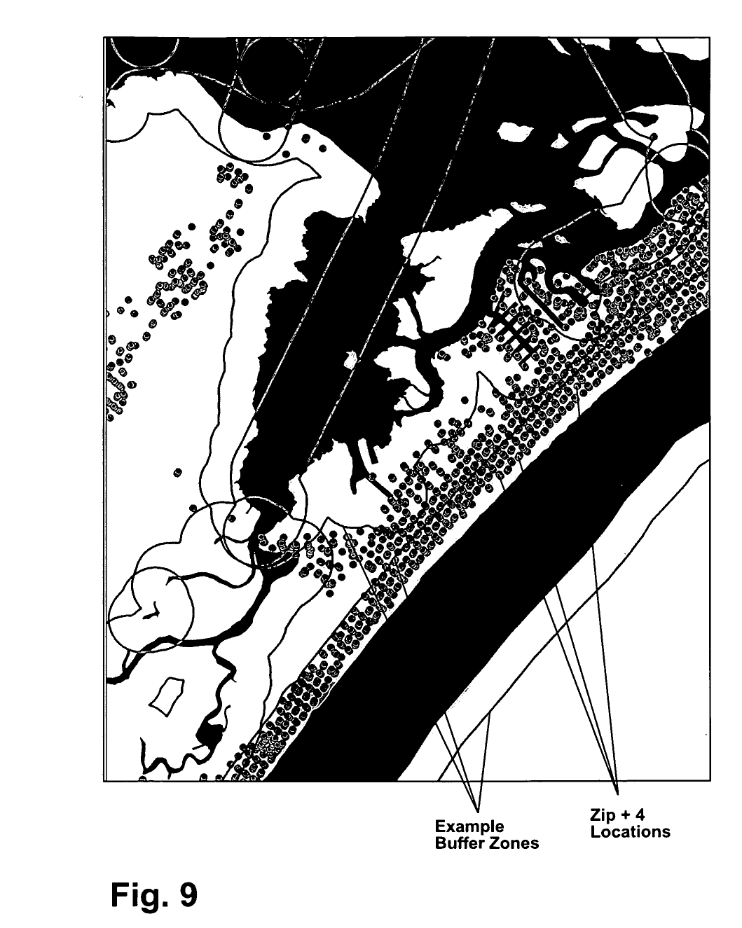

FIG. 7 is an enlarged portion of the map shown in FIG. 4 with various water areas of the State of New Jersey shown in a dark color. FIG. 8 is an enlarged portion of FIG. 5 of the same area shown in FIG. 7 showing various ZIP+4 regions laid onto the enlarged map of FIG. 7. FIG. 9 is an enlarged portion of the map of FIG. 6 showing lines defining a buffer zone, shown by example in the drawings as a ⅛-mile inland circumference around each body of water shown on the maps of FIGS. 7-9, whereby ZIP+4 regions lying within the ordered buffer zones comprise the targeted consumers for generation of the address list via the method shown in FIGS. 2-3.

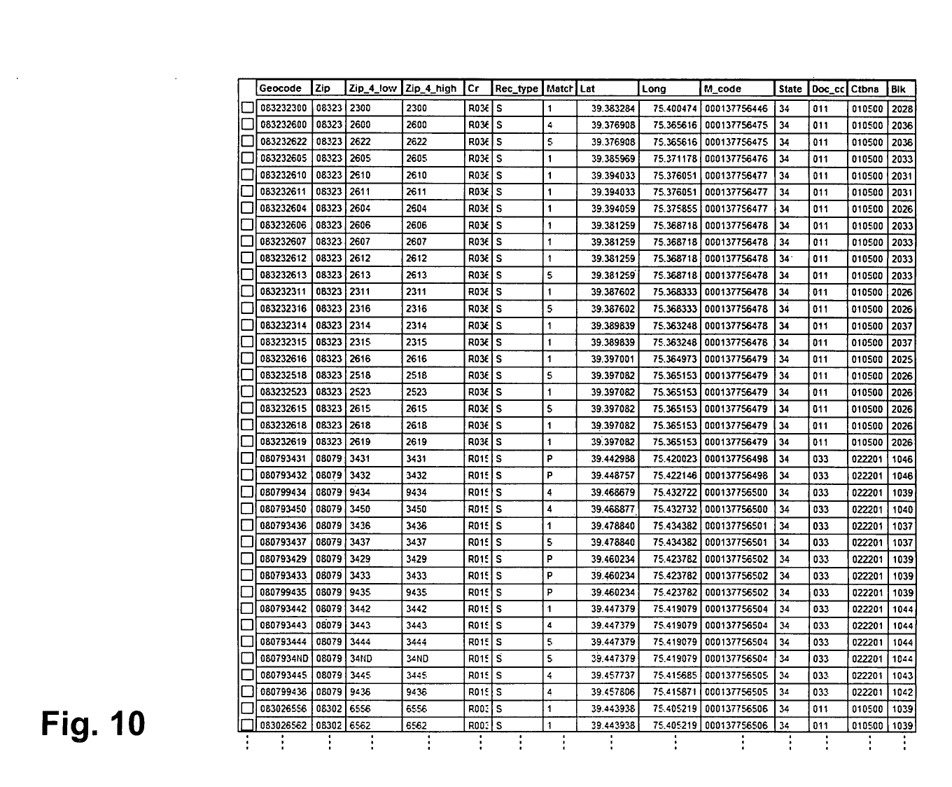

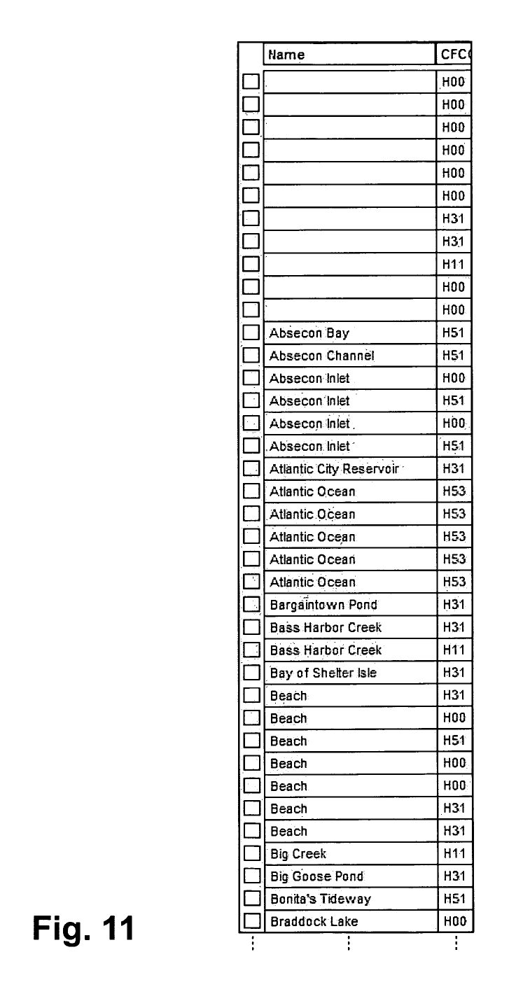

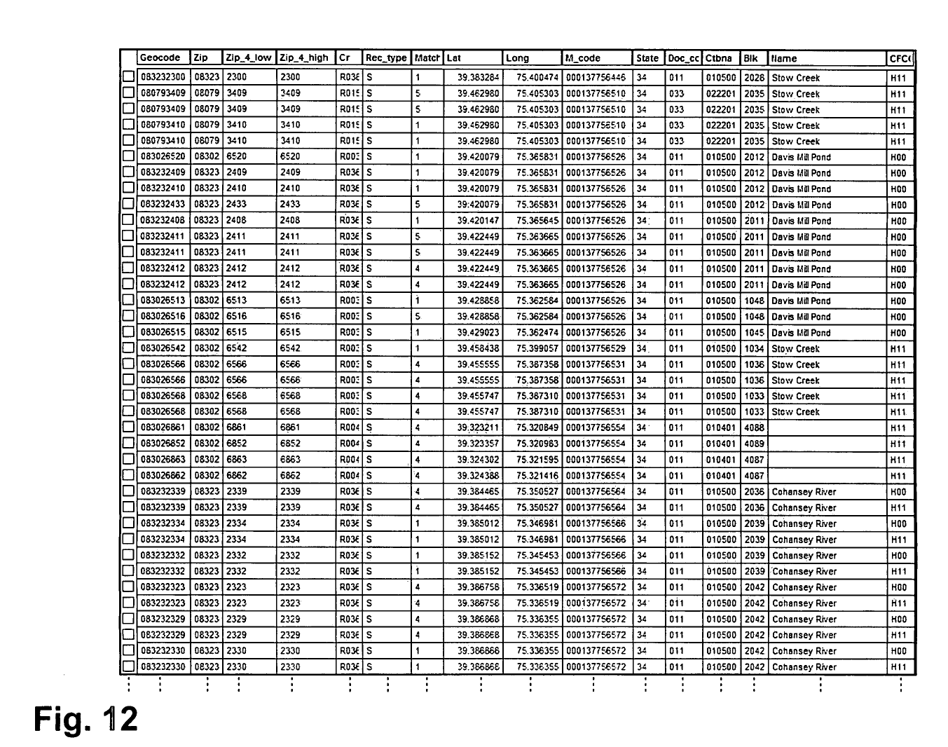

FIG. 10 shows an example table of ZIP+4 data contained in a typical mapping software package which data includes fields for ZIP code, ZIP+4 code, latitude, longitude, state, postal routes, and other geographical identifying data. FIG. 11 shows a list of selected records identifying a body of water existing in the State of New Jersey issue in the maps of FIGS. 4-9 as well as a code identifying the particular body of water. FIG. 12 shows an example query with the water boundary data having a buffer zone shown in FIG. 10 combined with the water boundary codes shown in FIG. 11 whereby the ZIP+4 codes listed in FIG. 12 are applied against an address list database to generate a targeted list of addresses comprising only those homes having a ZIP+4 code falling within the data shown in FIG. 12.

By acquiring different software datasets and combining them according to the invention, a user of the method and system 10 is able to identify homes that are further than (or within) 950 feet (or any other distance making up the selected buffer zone) of the shoreline of any body of water. Whether it is the Atlantic or Pacific Ocean, the Mississippi or Ohio Rivers, one of the Great lakes, or an inland lake or river, a user of various databases can identify various parts of this solution. In the example shown herein, the databases that are used are:
Water boundary sets that include rivers (excluding creeks and small drainage channels); and
A ZIP+4 point file database which includes every ZIP+4 for the United States where the center point, or centroid, of each ZIP+4 area is coded by latitude and longitude so that it can be imported into mapping software.

These two databases are the core of the system and method 10. By importing the two databases into a commercially-available mapping software program (e.g., Mapinfo Professional® 8.0) and placing two layers on the map, i.e., a water boundary layer and a ZIP+4 layer, the user is able to see the relative special relationship between the water, a selected boundary, whether or not a buffer zone is included, and the ZIP+4 codes that surround the water.

The next step is for the user to use a process called “buffering” which is a tool used in most advanced mapping software. By using the water boundary as the basis, a “buffer” is created around the edge of the water. In the case of a lake, the buffer surrounds the outer rim of the lake, for a river the buffer follows the edge of the river. These buffers can be set to any diameter. In order to minimize waste, it has been determined that 0.18 mile (950 feet) is generally close enough to capture only homes on the water, yet far enough away from the lakeshore to include the ZIP+4 within the buffer zone. If the buffer zone does not hit the ZIP+4 centroid or include it, that ZIP+4 will be ignored by the program and not included in the final dataset.

Once the buffer is complete, the user instructs the mapping software to take any ZIP+4 that hits or is within the selected buffer zone and to extract that ZIP+4 along with the latitude and longitude, ZIP code, and body of water name from the database, and place that data in a separate file, indexed by ZIP+4 codes. This database of ZIP+4 codes can then be imported into any mailing list database and used to identify homeowners or residents who live within each ZIP+4.

The benefits from the method and system 10 are clear. The prior art process involved an average of 1.25 hours to code a single county. The system and method 10 require approximately 15 minutes to code the same county data, with improved accurately and effectiveness for an entire state. What would take over 5,000 hours to complete using prior art methods, will take about 20 hours using the herein-described system and method 10.

The method and system 10 can be utilized for not only lakeshore homeowner use, but also for prospects living along railroad tracks or highways, near ski resorts or golf courses, or near virtually any type of geographical feature that can be coded by the computer. The accuracy of the database makes it highly effective in its ability to accurately and quickly identify targeted households surrounding a geographical feature. The savings generated by being able to target only those prospects surrounding a geographical feature is significant. From 15,000 households at the ZIP-code level, to 5,600 households at the carrier route level to 1,200 households at the ZIP+4 level, direct marketers can reduce their cost by between 80 and 92%.

The system and method 10 will now be described in an exemplary manner. A readily-available mapping software package that has advanced data analysis capabilities, such as Mapinfo Professional® 8.0, can be used. In addition, the method employs a database that contains water boundaries for each county in each state, and a database of all ZIP+4 centroids for each state.

Boundaries from the water boundary database are imported into the mapping software. Typically, each set of water boundaries comes with other datasets that are not needed for this process, so the water boundary files (four for each county) can be extracted and placed into a common location to contain all county water boundary datasets. The user can then employ the mapping software to aggregate all of the water boundaries in each state into one master database. For example, Mapinfo Professional® 8.0 provides a MapBasic® utility to accomplish this purpose. The user can run the MapBasic® program, select the files in the folder that are to be aggregated, select one dataset as the master, and select all other water boundary datasets for the aggregation process. All of the individual county water boundary datasets are then combined into one large master database. With 3,077 counties in the United States (including Louisiana parishes and Alaska boroughs), this process can consolidate the number of water databases to 51 (the District of Columbia is included with the 50 states).

Once this database is built, the user can open the state water boundary file as a layer in the mapping software. Then the user can import the ZIP+4 database into the mapping software. The water boundary information is not typically available resident as a file format compatible with the mapping software, so a conversion may need to be performed. For example, when using Mapinfo® as the mapping software, the user can import the water boundary data, and convert the latitude and longitude to a correct format, and then save the ZIP+4 database as a new Mapinfo® table. The conversion of the latitude and longitude may require multiplying the longitude by −1 to create a negative number for longitude, since many mapping software packages use a negative number for longitude for referencing the Western Hemisphere, while the water boundary data for U.S. counties is provided with the longitude value as a positive number.

Once the file is converted and imported, the user can open the ZIP+4 database in the same mapping window as the water boundary file. The user can then convert the latitude and longitude into a point file by instructing the computer to place a dot at the exact latitude and longitude for each ZIP+4 in the database. This process is done in the “create points” function in Mapinfo®. The user can then select create points, enter the location of the latitude (Y coordinate) and longitude (X coordinate) for the state ZIP+4 database, enter −1 for the longitude multiplier, and continue the software process. The dots are created for the user in a browsing window, and appear on the map as a new layer overlying the water boundary layer, which is the basis for creating buffers and the extraction of the relevant ZIP+4 codes.

The next step is to create the buffer. The user can use the mapping software (e.g., Mapinfo®) and:
1. Select a buffer;
2. Select the water boundary file;
3. Select “new” and select “keep water boundary file data/format;”
4. Select “open new Buffer,” deselect “Open new Mapper,” select “Add to current Mapper;”
5. Select “keep existing new table structure;”
6. Select “create;”
7. Create a new file name (name file);
8. Select “next;”
9. The Buffer Objects screen opens;
10. Choose a distance value, such as 0.18 mile, or other distance for the buffer zone;
11. Select “Units (Miles);”
12. Select “Smoothness” (99 indicates how smooth the circle will be);
13. Deselect “one buffer for all objects;”
14. Select “one buffer for each object” (for a river or large lake, each buffer will be drawn; when one buffer is complete, a new one will be added next to it until all the buffers are drawn);
15. Select “Next;”
16. The “Data Aggregation” input screen appears:
17. Accept the default settings;
18. Set “Value” equals “blank;”
19. Select “OK.”

The computer will then process and create a buffer around every water object contained in the water boundary database and import those buffers onto the map overlaying the water boundary file and ZIP+4 file.

Once the buffers are complete, the user can issue a query to the mapping software. For example:
1. Select “query SQL Select;”
2. In the “query SQL Select” screen, select the ZIP+4 table for the state;
3. Select the water boundary buffer file that was just created. The two files will automatically link with a query instruction of “ZIP4_*.Obj Within *Lakeshore_ZIP4_Buffer.Obj” where the asterisk represents the individual file name or state name being used at the time;
5. Select “verify” to verify the syntax of the query;
6. Select “display results as a table;”
7. Select “OK” to process the query.

A file will appear that contains the ZIP+4, ZIP code, ZIP+4 number alone, the latitude and longitude of that segment, and the lake name (see FIG. 12).

This file can be saved as a text file which is then imported into either Microsoft Excel or Microsoft Access (if there are fewer than 62,500 records Excel can be used; with over 62,500 records, the file must be opened in Access) or any other spreadsheet or database software, and the file is processed to make it compatible with whatever mailing service that the user uses to create the mailing list. This text file can then be imported into any mailing list company database, such as that identified in the FIGURES with reference numeral 20, to extract those names and addresses that fall within a given ZIP+4.

While the invention has been specifically described in connection with certain specific embodiments thereof, it is to be understood that this is by way of illustration and not of limitation. Reasonable variation and modification are possible within the scope of the forgoing disclosure and drawings without departing from the spirit of the invention which is defined in the appended claims.

What is claimed is:

1. A method for generating an address list from a database of addresses, comprising the steps of:
receiving at least one geographical criterion from a user;
identifying a first geographical region from a user;
forming a second geographical region by modifying the first geographical region pursuant to the at least one geographical criterion, wherein the second geographical region is not of the same geographical size as the first geographical region;
generating a list of addresses from the database of addresses which fall within the second geographical region.

2. The method of claim 1 wherein the second geographical region is smaller than the first geographical region.

3. The method of claim 1 wherein the second geographical region is larger than the first geographical region.

4. The method of claim 1 wherein the at least one geographical criterion comprises a user-selected distance.

5. The method of claim 4 wherein the second geographical region is formed by applying the user-selected distance to form a circumferential buffer zone offset from the first geographical region.

6. The method of claim 1 and further comprising the step of applying a database of ZIP+4 codes against the second geographical region.

7. The method of claim 6 and further comprising the step of determining a subset of ZIP+4 codes which fall within the second geographical region.

8. The method of claim 7 wherein the step of generating a list of addresses from the database of addresses which fall within the second geographical region comprises generating a list of all addresses which include the subset of ZIP+4 codes.
